(19) United States
(12) Patent Application Publication
(10) Pub. No.: US 2012/0246890 A1
(43) Pub. Date: Oct. 4, 2012

(54) ZIPPER WITH ATTACHED FASTENER

(76) Inventor: John Luis Hernandez, Bonita, CA (US)

(21) Appl. No.: 13/246,158

(22) Filed: Sep. 27, 2011

Related U.S. Application Data
(60) Provisional application No. 61/386,719, filed on Sep. 27, 2010.

(51) Int. Cl. A44B 19/26; B23P 11/00

(52) U.S. Cl. 24/436; 29/408

(57) ABSTRACT

One example embodiment includes a system for securing a zipper. The system includes a zipper and a fastener, where the fastener is configured to secure the position of the zipper.

### CROSS-REFERENCE TO RELATED APPLICATIONS

This application claims the benefit of and priority to U.S. Provisional Patent Application Ser. No. 61/386,719 filed on Sep. 27, 2010, which application is incorporated herein by reference in its entirety.

### BACKGROUND OF THE INVENTION

Zippers are a common type of fastener. Their use goes backs hundreds of years as a convenient method of attaching two items to one another. Their use ranges from clothing to upholstery to luggage and many other items. Their popularity arises, in part, from the strength of the connection. I.e., each individual connection is weak, but taken together the connection can be very strong and durable. In addition, the connection can be undone whenever desired by the user, allowing the user to configure the connection in any desired manner.

Zippers do have a number of drawbacks, however. For example, the connection by the zipper prevents larger debris from passing though the connection but smaller debris can penetrate the zipper. This is particularly true on the ends, where there may be a larger opening to accommodate movement of the zipper and to maintain flexibility.

The debris that can pass through this opening is numerous, including liquids, dust and bugs depending on the size of the opening. In addition, this opening can, by design, be enlarged when desired. This means that the opening can grow larger over time, through the movement of critters or through force which “opens” the zipper in minute amounts applied numerous times or over long periods of time.

Accordingly, there is a need in the art for a system which can secure the position of the zipper. Additionally, there is a need for the system to be releasable if a user desires to change the position of the zipper.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for securing a zipper. The system includes a zipper and a fastener, where the fastener is configured to secure the position of the zipper.

Another example embodiment includes a system for securing a zipper. The system includes a cloth. The cloth includes a first portion and a second portion where the second portion is configured to separate from the first portion. The system also includes a zipper, where the zipper is attached to the cloth. The zipper includes a first set of teeth attached to the first portion of the cloth and a second set of teeth attached to the second portion of the cloth. The zipper also includes a slider, where the slider is configured to move along the first set of teeth and second set of teeth. They system also includes a fastener. The fastener includes a first portion attached to the zipper and a second portion attached to the cloth and is configured to secure the position of the zipper relative to the cloth.

Another example embodiment includes a method of manufacturing a system for securing a zipper. The method includes providing a zipper and providing a fastener, where the fastener is configured to secure the position of the zipper.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a top view of a system for securing a zipper;

FIG. 1B illustrates a side view of the system for securing a zipper;

FIG. 2A illustrates a top view of an example of a fastener;

FIG. 2B illustrates a side view of the example of a fastener; and

FIG. 3 is a flow chart illustrating a method of manufacturing a system for securing a zipper.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

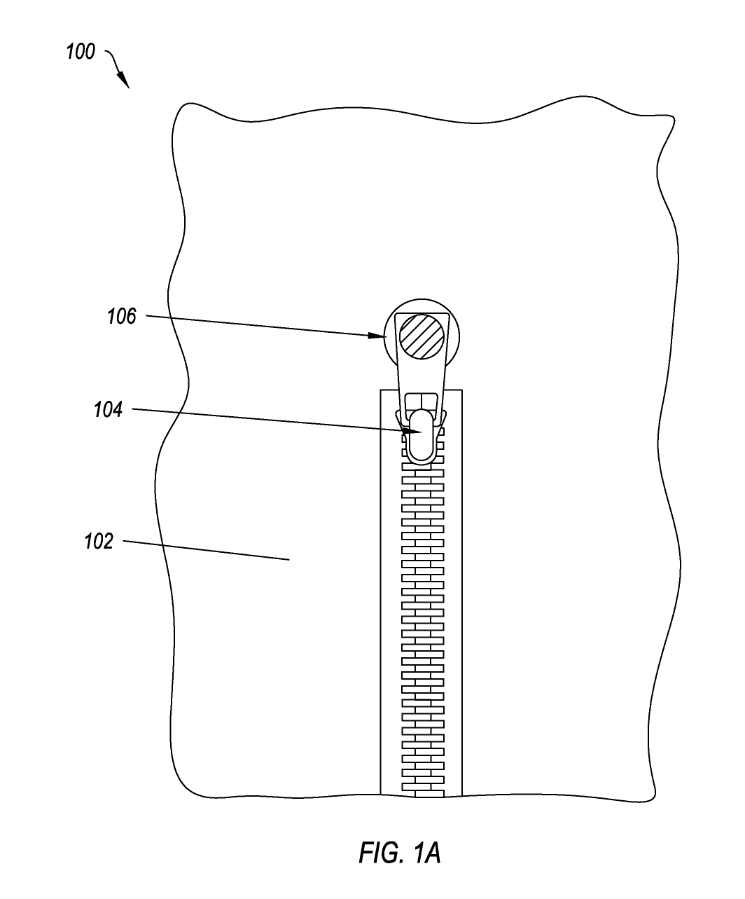

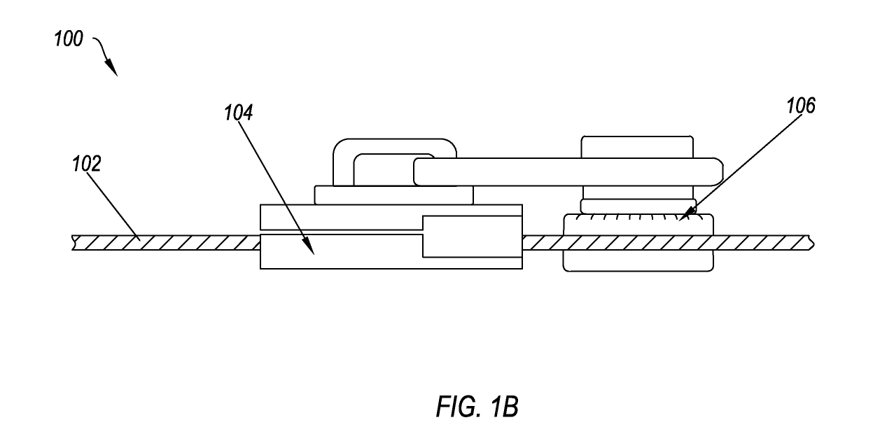

FIGS. 1A and 1B illustrate a system 100 for securing a zipper. FIG. 1A illustrates a top view of the system 100 for securing a zipper; and FIG. 1B illustrates a side view of the system 100 for securing a zipper. In at least one implementation, the system 100 can prevent the zipper from opening unless so desired. In particular, the system 100 can be used to ensure that the zipper remains in the closed position until desired by the user.

FIGS. 1A and 1B show that the system 100 can include a cloth 102. In at least one implementation, the cloth 102 can include any desired material. For example, the cloth 102 can include leather, artificial leather, suede, vinyl, a fabric or any other desired material. The cloth 102 can be used for any desired purpose. For example, the cloth 102 can include clothing, bedding, upholstery covers or any other desired covering or material. For example, the system 100 can be used on mattress and boxspring encasement covers and other uses that may require this type of fastening security.

Leather is a durable and flexible material created via the tanning of putrescible animal rawhide and skin, primarily cattlehide. Artificial leather includes any fabric or finish intended to substitute for leather where a leather-like finish is desired but the actual material is cost-prohibitive or unsuitable. Suede includes kid or other leather finished with a soft, napped surface, on the flesh side or on the outer side after removal of a thin outer layer. Vinyl includes any resin formed by polymerization of vinyl compounds or plastics made from such resins. A vinyl compound is any organic compound that contains a vinyl group (Preferred IUPAC name ethenyl). Vinyl groups (formula —CH═CH2) are derivatives of ethene, CH2=CH2, with one hydrogen atom replaced with some other group.

Fabrics include any network of natural or artificial fibers including textiles. In at least one implementation, the fibers can include thread or yarn. For example, yarn can be produced by spinning raw wool fibers, linen, cotton, or other material on a spinning wheel to produce long strands. Fabrics can be formed by weaving, knitting, crocheting, knotting, or pressing fibers together, such as in felt. One of skill in the art will appreciate that a fabric can include a single fiber or more than one fiber.

In at least one implementation, fibers, also spelled fibres, is a class of materials that are continuous filaments or are in discrete elongated pieces. In particular, fibers can be spun into filaments, string or rope, used as a component of composite materials, or matted into sheets to make products such as paper or felt. Additionally or alternatively, fibers can include yarn, thread, string, filaments, twine, cord, or any other material that can be used to form a fabric or cloth. In particular, yarn is a long continuous length of interlocked fibers, suitable for use in the production of textiles, sewing, crocheting, knitting, weaving, embroidery and rope making. Additionally or alternatively, thread is a type of yarn intended for sewing by hand or machine. Yarn and/or thread may be finished with wax or other lubricants to withstand the stresses involved in sewing or otherwise manufacturing the fabric.

Natural fibers can include animal fibers such as alpaca, angora, bison down, camel hair, cashmere, catgut, chiengora, guanaco, llama, mohair, pashmina, qiviut, rabbit, silk, sinew, spider silk, wool, vicuna, and yak; vegetable fibers such as aback bamboo, coir, cotton, flax, hemp, jute, kapok, kenaf, piña, raffia palm, ramie, sisal, and wood; mineral fibers such as asbestos, basalt, mineral wool, and glass wool; and cellulose fibers such as acetate, art silk, bamboo, lyocell (tencel), modal, and rayon; or any other natural fiber. Synthetic fibers can include acrylic, aramid (twaron, kevlar, technora, and nomex), carbon (tenax), derclon, microfiber, modacrylic, nylon, olefin, polyester, polyethylene (dyneema, spectra), spandex, vinalon, zylon, or any other synthetic fiber. One of skill in the art will appreciate that fibers can include any natural or synthetic fibers, or any combination thereof, without restriction and without limitation unless otherwise indicated in the claims.

In at least one implementation, the fibers can be used to form a grid. In particular, the first set of fibers can be oriented in a “horizontal” direction; that is, the first set of fibers can be oriented parallel to one another. One of skill in the art will appreciate that horizontal orientation refers to an arbitrary orientation and is not used to limit or restrict the scope of the claims unless otherwise indicated in the claims. Further, the first set of fibers can be spaced equidistant from one another or in a repeating pattern. For example, a first fiber in the first set of fibers might be relatively close to a second fiber in the first set of fibers, which is, in turn, relatively farther from a third fiber in the first set of fibers, with the pattern repeating throughout the fabric. One of skill in the art will appreciate that the spacing of the first set of fibers can be any distance from one another without restriction and without limitation unless otherwise indicated in the claims.

The second set of fibers can be oriented in a “vertical” direction; that is, the second set of fibers can be oriented parallel to one another. One of skill in the art will appreciate that vertical orientation refers to an arbitrary orientation perpendicular to the first set of fibers and is not used to limit or restrict the scope of the claims unless otherwise indicated in the claims. Further, the second set of fibers can be spaced equidistant from one another or in a repeating pattern. For example, a first fiber in the second set of fibers might be relatively close to a second fiber in the second set of fibers, which is, in turn, relatively farther from a third fiber in the second set of fibers, with the pattern repeating throughout the fabric. One of skill in the art will appreciate that the spacing of the second set of fibers can be any distance from one another without restriction and without limitation unless otherwise indicated in the claims.

In at least one implementation, the fibers can be woven together. In particular, weaving is the textile art in which a first set of fibers and a second set of fibers, called the warp and the filling or weft (older woof), respectively, are interlaced with each other to form a fabric or cloth. In particular, the first set of fibers can be held in place while the second set of fibers is woven through them or vice versa. The manner in which the first set of fibers and the second set of fibers interlace with each other is known as the weave. In particular, the weave can include plain weave, satin weave, and twill or any other type of weave.

In at least one implementation, plain weave can include the first set of fibers and second set of fibers aligned so they form a simple criss-cross pattern. Each fiber in the second set of fibers crosses the first set of fibers by going over one, then under the next, and so on. The next fiber in the second set of fibers goes under the first set of fibers that its neighbor went over, and vice versa. The satin weave is characterized by four or more fibers in the second set of fibers floating over a fiber in the first set of fibers or vice versa, four or more fiber in the first set of fibers floating over a single fiber in the second set of fibers. Twill is a type of fabric woven with a pattern of diagonal parallel ribs. It is made by passing the second set of fibers over one or more first set of fibers and then under two or more first set of fibers and so on, with a “step” or offset between rows to create the characteristic diagonal pattern.

FIGS. 1A and 1B also show that the system 100 can include a zipper 104. In at least one implementation, the zipper 104 (aka zip or zip fastener) includes a device for temporarily joining two edges of the cloth 102. I.e., the cloth 102 can include two portions which are unattached to one another and the zipper 104 can be configured to attach the two portions to one another. Additionally or alternatively, the zipper 104 can attach the cloth 102 to an external object.

FIGS. 1A and 1B further show that the system 100 can include a fastener 106. In at least one implementation, the fastener 106 can secure the zipper 104 in a desired position. I.e., the fastener 106 can prevent the zipper 104 from either being opened (allowing the two edges to be separated) or closed (preventing the two edges from being separated).

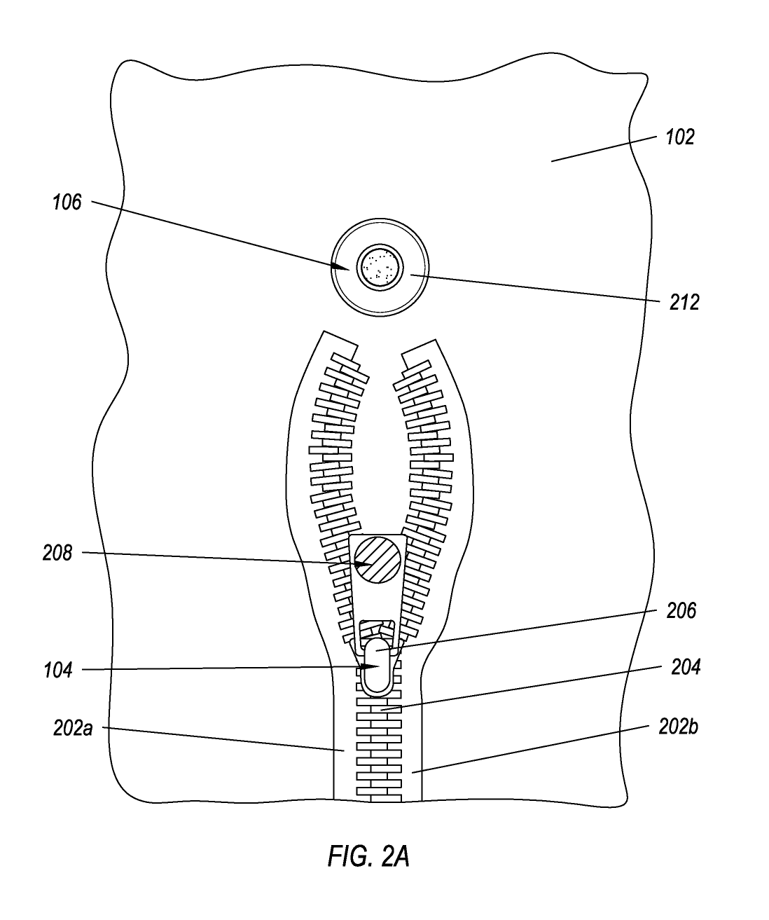

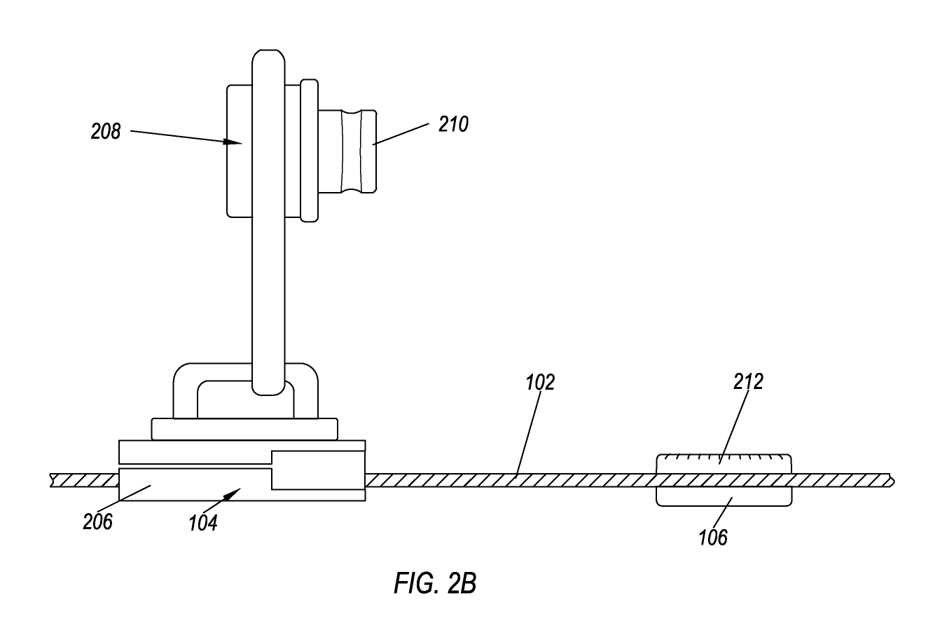

FIGS. 2A and 2B illustrate an example of a fastener 106 for securing a zipper 104. FIG. 2A illustrates a top view of the example of a fastener 106; and FIG. 2B illustrates a side view of the example of a fastener 106. In at least one implementation, the fastener 106 can prevent debris or other material from passing around the zipper 104. For example, the fastener 106 can prevent bugs or other undesirable debris from passing around the zipper 104.

FIGS. 2A and 2B show that the zipper 104 can include a first strip of fabric tape 202a and a second strip of fabric tape 202b (collectively “strip of fabric tape 202”). In at least one implementation, each strip of fabric tape 202 can be affixed to one of the two pieces of fabric 102 to be joined. I.e., the strips of fabric tape 202 can be attached to the fabric 102 such that the zipper 104 can either connect or disconnect the pieces of the fabric, as desired. For example, the zipper 104 may increase or decrease the size of an opening to allow or restrict the passage of objects, as in the fly of trousers or in a pocket. The zipper 104 may also join or separate two ends or sides of a single garment, as in the front of a jacket, dress or skirt. The zipper 104 may further attach or detach a separable part of the garment to or from another, as in the conversion between trousers and shorts or the connection/disconnection of a hood and a coat. The zipper 104 may additionally be used to decorate an item. These variations are achieved by sewing one end of the zipper 104 together, sewing both ends together, or allowing both ends of the zipper 104 to fall completely apart. One of skill in the art will appreciate that these uses are not necessarily exclusive of one another. I.e., the zipper 104 can fill one or more of these functions as well as other desired functions simultaneously.

FIGS. 2A and 2B also show that the zipper 104 can include from two to hundreds of specially shaped teeth 204. In at least one implementation, the teeth 204 can be configured to join with one another. That is, a first side of the teeth 204 can be configured to mate with the opposite side of the teeth 204, so that the teeth 204 can mate with one another. The teeth 204 can be include individual elements each formed and attached to the strips fabric tape 202 or formed directly onto the strips of fabric tape 202. Additionally or alternatively, the teeth 204 can be shaped from a continuous coil, and are also referred to as elements. The teeth 204 can be formed from any desired material, such as metal or plastic.

FIGS. 2A and 2B further show that the zipper 104 can include a slider 206. In at least one implementation, the slider 206 can move along the rows of teeth 204. Inside the slider 206 is a Y-shaped channel that meshes together or separates the opposing rows of teeth 204, depending on the direction of the movement of the slider 206. The zipper 104 can include two sliders 204, allowing variation in the opening's size and position. For example, in most jackets and similar garments, the opening is closed entirely when one slider 204 is at each end. In contrast, in most baggage, the opening is closed entirely when the two sliders 204 are next to each other at any point along the zipper 104.

FIGS. 2A and 2B additionally show that the fastener 106 can include a snap 208 (also called snap fastener, popper, and press stud). In at least one implementation, the snap 208 can include a catch or fastener that closes by pressure. I.e., the snap 208 can include two or more portions that are attached to one another by aligning them in the correct orientation and pressing them against one another. One of skill in the art will appreciate that the snap 208 as used herein is exemplary and not limiting unless otherwise specified in the claims. For example, the fastener 106 can include a hook and loop fastener, a magnet, a button or any other desired mechanism.

FIGS. 2A and 2B also show that the snap 208 can include a stud 210. In at least one implementation, the stud 210 is attached to the slider 204. For example, the stud 210 can be attached through a hole in the handle of the slider 204 of a conventional zipper 104. For example, the stud 210 can be riveted, glued, welded or otherwise attached to the slider 204. Additionally or alternatively, the stud 210 can be created as part of the slider 204. I.e., the slider 204 and the stud 210 can be a single piece of material. The snap 208 can include a groove around the circumference of the stud 210.

FIGS. 2A and 2B also show that the snap 208 can include a disk 212. In at least one implementation, the disk 212 can include a hole for received the stud 210. In addition, the disk 212 can include a lip or other fixture that narrows the width of the hole at the opening. The lip can be configured to mate with a groove on the stud 210 such that when pressure is used to insert the stud 210 into the disk 212, the lip and the groove mate to prevent the stud 210 from being removed without an exertion of force by the user.

In at least one implementation, the fastener 106 can be added to an existing cloth 102 and zipper 104. For example, the stud 210 can be two or more pieces, one of which is passed through a portion of the slider 206 and attached to the other pieces. I.e., a portion of the stud 210 can be inserted through a hole in a handle of a slider 206 and attach to other portions of the stud 210. Additionally or alternatively, the disk 212 can include two or more pieces, one of which is passed through a portion of the cloth 102 and attached to the other pieces. I.e., a portion of the disk 212 can pierce the cloth 102 and attach to other portions of the disk 212.

In at least one implementation, the snap 208 can include an apparatus to make removing the stud 210 from the disk 212 easier for the user. For example, the snap 208 can include a tab connected to the slider 204. The user can pull on the tap providing sufficient force to remove the stud 210 from the disk 212.

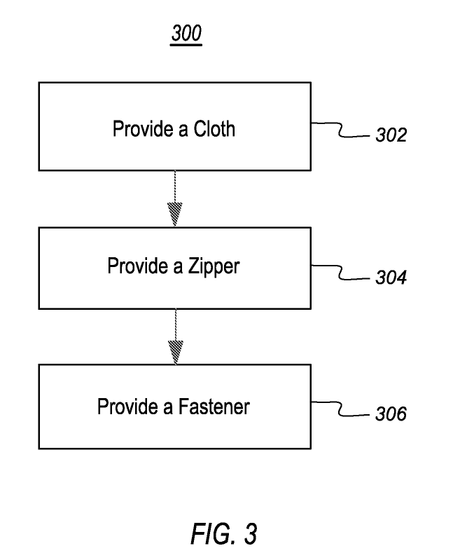

FIG. 3 is a flow chart illustrating a method 300 of manufacturing a system for securing a zipper. In at least one implementation, the system can be the system 100 of FIGS. 1A, 1B, 2A and 2B. Therefore, the method 300 will be described, exemplarily, with reference to the system 100 of FIGS. 1A, 1B, 2A and 2B. Nevertheless, one of skill in the art can appreciate that the method 300 can be used to a system other than the system 100 of FIGS. 1A, 1B, 2A and 2B.

FIG. 3 shows that the method 300 can include providing a cloth 302. In at least one implementation, the cloth can include any desired material. For example, the cloth can include leather, artificial leather, suede, vinyl, a fabric or any other desired material. The cloth can be used for any desired purpose. For example, the cloth can include clothing, bedding, upholstery covers or any other desired covering or material. For example, the system can be used on mattress and boxspring encasement covers and other uses that may require this type of fastening security.

FIG. 3 also shows that the method 300 can include providing a zipper 304. In at least one implementation, the zipper includes a device for temporarily joining two edges of the cloth. I.e., the cloth can include two portions which are unattached to one another and the zipper can be configured to attach the two portions to one another. Additionally or alternatively, the zipper can attach the cloth to an external object.

In at least one implementation, the zipper can include a first strip of fabric tape and a second strip of fabric tape (collectively “strip of fabric tape”). Each strip of fabric tape can be affixed to one of the two pieces of fabric to be joined. I.e., the strips of fabric tape can be attached to the fabric such that the zipper can either connect or disconnect the pieces of the fabric, as desired. For example, the zipper may increase or decrease the size of an opening to allow or restrict the passage of objects, as in the fly of trousers or in a pocket. The zipper may also join or separate two ends or sides of a single garment, as in the front of a jacket, dress or skirt. The zipper may further attach or detach a separable part of the garment to or from another, as in the conversion between trousers and shorts or the connection/disconnection of a hood and a coat. The zipper may additionally be used to decorate an item. These variations are achieved by sewing one end of the zipper together, sewing both ends together, or allowing both ends of the zipper to fall completely apart. One of skill in the art will appreciate that these uses are not necessarily exclusive of one another. I.e., the zipper can fill one or more of these functions as well as other desired functions simultaneously.

In at least one implementation, the zipper can include from two to hundreds of specially shaped teeth. The teeth can be configured to join with one another. That is, a first side of the teeth can be configured to mate with the opposite side of the teeth, so that the teeth can mate with one another. The teeth can be include individual elements each formed and attached to the strips fabric tape or formed directly onto the strips of fabric tape. Additionally or alternatively, the teeth can be shaped from a continuous coil, and are also referred to as elements. The teeth can be formed from any desired material, such as metal or plastic.

In at least one implementation, the zipper can include a slider. The slider can move along the rows of teeth. Inside the slider is a Y-shaped channel that meshes together or separates the opposing rows of teeth, depending on the direction of the movement of the slider. The zipper can include two sliders, allowing variation in the opening's size and position. For example, in most jackets and similar garments, the opening is closed entirely when one slider is at each end. In contrast, in most baggage, the opening is closed entirely when the two sliders are next to each other at any point along the zipper.

FIG. 3 further shows that the method 300 can include providing a fastener 306. In at least one implementation, the fastener can secure the zipper in a desired position. I.e., the fastener can prevent the zipper from either being opened (allowing the two edges to be separated) or closed (preventing the two edges from being separated).

In at least one implementation, the fastener can include a snap. The snap can include a catch or fastener that closes by pressure. I.e., the snap can include two or more portions that are attached to one another by aligning them in the correct orientation and pressing them against one another. One of skill in the art will appreciate that the snap as used herein is exemplary and not limiting unless otherwise specified in the claims. For example, the fastener can include a hook and loop fastener, a magnet, a button or any other desired mechanism.

In at least one implementation, the snap can include a stud. The stud is attached to the slider. For example, the stud can be attached through a hole in the handle of the slider of a conventional zipper. For example, the stud can be riveted, glued, welded or otherwise attached to the slider. Additionally or alternatively, the stud can be created as part of the slider. I.e., the slider and the stud can be a single piece of material. The stud can include a groove around the circumference of the stud.

In at least one implementation, the snap can include a disk. The disk can include a hole for received the stud. In addition, the disk can include a lip or other fixture that narrows the width of the hole at the opening. The lip can be configured to mate with a groove on the stud such that when pressure is used to insert the stud into the disk, the lip and the groove mate to prevent the stud from being removed without an exertion of force by the user.

In at least one implementation, the fastener can be added to an existing cloth and zipper. For example, the stud can be two or more pieces, one of which is passed through a portion of the slider and attached to the other pieces. I.e., a portion of the stud can be inserted through a hole in a handle of a slider and attach to other portions of the stud. Additionally or alternatively, the disk can include two or more pieces, one of which is passed through a portion of the cloth and attached to the other pieces. I.e., a portion of the disk can pierce the cloth and attach to other portions of the disk.

In at least one implementation, the snap can include an apparatus to make removing the stud from the disk. For example, the snap can include a tab connected to the slider. The user can pull on the tap providing sufficient force to remove the stud from the disk.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for securing a zipper, the system comprising:
a zipper; and
a fastener, wherein the fastener is configured to secure the position of the zipper.

2. The system of claim 1, wherein the fastener includes a snap.

3. The system of claim 1, wherein the fastener includes a hook and loop fastener.

4. The system of claim 1, wherein the fastener includes a magnet.

5. The system of claim 1, wherein the fastener includes a button.

6. The system of claim 1, further comprising a cloth, wherein the zipper is attached to the cloth.

7. The system of claim 6, wherein the cloth includes a fabric.

8. The system of claim 6, wherein the cloth includes leather.

9. The system of claim 6, wherein the cloth includes artificial leather.

10. The system of claim 6, wherein the cloth includes vinyl.

11. The system of claim 6, wherein the cloth includes a mattress cover.

12. A system for securing a zipper, the system comprising:
a cloth, wherein the cloth includes:
a first portion; and
a second portion;
wherein the second portion is configured to separate from the first portion;
a zipper, wherein the zipper:
is attached to the cloth; and
includes:
a first set of teeth attached to the first portion of the cloth;
a second set of teeth attached to the second portion of the cloth; and
a slider, wherein the slider is configured to move along the first set of teeth and second set of teeth; and
a fastener, wherein the fastener:
includes:
a first portion attached to the zipper; and
a second portion attached to the cloth; and
is configured to secure the position of the zipper relative to the cloth.

13. The system of claim 12, wherein:
the first portion includes a stud; and
the second portion includes a hole;
wherein the stud is configured to be inserted into the hole.

14. The system of claim 13, wherein the stud includes a groove.

15. The system of claim 14, wherein the hole includes a lip, wherein the lip is configured to mate with the groove of the stud.

16. The system of claim 12, wherein:
the first portion includes a hole; and
the second portion includes a stud;
wherein the stud is configured to be inserted into the hole.

17. A method of manufacturing a system for securing a zipper, the method comprising:
providing a zipper; and
providing a fastener, wherein the fastener is configured to secure the position of the zipper.

18. The method of claim 17, wherein the fastener is configured to secure the position of the zipper if the zipper is located near one end of the zipper.

19. The method of claim 17, wherein the fastener includes a snap.

20. The method of claim 17, wherein the fastener includes:
a stud, wherein the stud includes:
a first portion;
a second portion; and
a connector, wherein the connector is configured to pass through a portion of the zipper and connect the first portion and the second portion; and
a disk, wherein the
a first portion;
a second portion; and
a connector, wherein the connector is configured to pass through a portion of a cloth and connect the first portion and the second portion.
